(19) United States
(12) Patent Application Publication
(10) Pub. No.: US 2008/0117329 A1
(43) Pub. Date: May 22, 2008

(54) Multi-mode video deinterlacer comprising a low delay mode

(76) Inventor: Richard Hayden Wyman, Sunnyvale, CA (US)

Correspondence Address: MCANDREWS HELD & MALLOY, LTD, 500 WEST MADISON STREET, SUITE 3400, CHICAGO, IL, 60661, US

(21) Appl. No.: 11/603,502

(22) Filed: Nov. 22, 2006

(51) Int. Cl. H04N 7/01

(52) U.S. Cl. 348/448; 348/E07.003

(57) ABSTRACT

Herein described is at least a method and system for deinterlacing an interactive or non-interactive video. The method comprises receiving a control signal by a user that indicates whether the video is an interactive video or a non-interactive video. The method further comprises deinterlacing the video such that an amount of delay to the video is incurred through a deinterlacer, wherein the amount of delay is based on the control signal. In a representative embodiment, the system comprises one or more first inputs for providing interactive video to a deinterlacer, one or more second inputs for providing non-interactive video to the deinterlacer, and a circuitry for selecting one input of the one or more first or the one or more second inputs based on a control signal.

### CROSS-REFERENCE TO RELATED APPLICATIONS/INCORPORATION BY REFERENCE

This application makes reference to:

U.S. patent application Ser. No. 10/945587 (Attorney Docket No. 15448US02) filed Sep. 21, 2004;

U.S. patent application Ser. No. 10/871758 (Attorney Docket No. 15449US02) filed Jun. 17, 2004;

U.S. patent application Ser. No. 10/945796 (Attorney Docket No. 15450US02) filed Sep. 21, 2004; and

U.S. patent application Ser. No. 10/945817 (Attorney Docket No. 15451US02) filed Sep. 21, 2004.

The above stated applications are hereby incorporated herein by reference in their entireties.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

When displaying video using a television set, it may be advantageous to incur several fields of processing delay through a television deinterlacer when deinterlacing reverse 3:2/2:2 pulldown video. The delay may be used to perform further processing of the 3:2/2:2 pull-down video, such that any discrepancies (bad-edits) can be detected and corrected before they are presented to the viewer.

But when a gamer plays a game using a game console connected to the television set, the processing delay that is typically used to perform deinterlacing of a 3:2/2:2 pull-down may result in an undesirable lag time that may annoy the gamer. The lag may affect a gamer's response time and may be especially noticeable to the gamer when playing a fast paced action game.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Various aspects of the invention provide a method and a system for implementing a high performance multi-mode deinterlacing of video. The various aspects are substantially shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a block diagram of a multi-mode video deinterlacer that is used to deinterlace interactive or non-interactive video when an interactive game console and/or a multimedia player is connected to the multi-mode video deinterlacer by way of using two connectors in accordance with an embodiment of the invention.

FIG. 2 is a detailed block diagram of a multi-mode video deinterlacer used to deinterlace interactive or non-interactive video when an interactive game console and/or a multimedia player is connected to the multi-mode deinterlacer using two connectors, in accordance with an embodiment of the invention.

FIG. 3 is a block diagram of a multi-mode video deinterlacer that is used to deinterlace interactive or non-interactive video when an interactive game console and/or a multimedia player is connected to the multi-mode video deinterlacer using a single connector, in accordance with an embodiment of the invention.

FIG. 4 is a detailed block diagram of a multi-mode video deinterlacer used to deinterlace interactive or non-interactive video when an interactive game console and/or a multimedia player is connected to the multi-mode deinterlacer using a single connector, in accordance with an embodiment of the invention.

FIG. 5 is an operational flow diagram of a multi-mode video deinterlacer, in accordance with an embodiment of the invention.

### DETAILED DESCRIPTION OF THE INVENTION

Various aspects of the invention provide at least a method and a system of providing multi-mode deinterlacing of video, based on whether the video is an interactive video or non-interactive video. For example, the video received may comprise an interactive video game, an interactive video conferencing session, or any non-interactive program such as a movie or television program. The deinterlacing may be performed on video that conforms to NTSC or PAL standards. The system that performs the multi-mode deinterlacing may be referred to as a multi-mode video deinterlacer hereinafter. The multi-mode video deinterlacer may provide deinterlacing of interlaced video along with improvement of visual quality of the displayed video. The multi-mode video deinterlacer may be incorporated into a display device. The display device may comprise a television set, set-top-box with monitor, or computer with monitor, for example. In accordance with the various aspects of the invention, the multi-mode video deinterlacer (MMVD) may deinterlace incoming video such that the video incurs a reduced or minimized video processing delay when the MMVD is placed into a particular low delay mode. For example, the multimode video deinterlacer may operate or function in an interactive (e.g., game mode or videoconferencing) mode and a non-interactive (e.g., movies, television program) mode. Various aspects of the invention allow the user to configure the multi-mode video deinterlacer into one of these two video processing modes to provide a more desirable viewing experience.

Aspects of the invention provide an enhanced gaming experience when a person plays games displayed over a television set or set-top-box. A gamer may utilize the various aspects of the invention by connecting and using one of several available game consoles to a television set that incorporates the multi-mode video deinterlacer. The one of several available game consoles may comprise a version of an XBOX, Playstation, or Nintendo type game console, for example. In a representative embodiment, the multi-mode video deinterlacer may be configured to operate in a particular processing mode by manual or remote control signals provided by a user. In a representative embodiment, a wireless remote control may be used to provide the remote control signals. When a user sets the multi-mode video deinterlacer into game mode, for example, video processing that would normally occur with a non-interactive video stream may be bypassed. For example, a deinterlacing mechanism that incorporates the use of reverse 3:2/2:2 pull-down of video may be bypassed. As a result, the delay associated with this processing is minimized, and lag time associated with such a delay reduced, thereby enhancing the user's interactive gaming experience. In other words, any lag in response time associated with a stimulus provided by a user may have a significant undesirable effect, especially when the game is a fast paced action game. On the other hand, when a typical non-interactive video program is provided to the television set or set-top-box, the multi-mode video deinterlacer may be configured to operate in a delayed mode such that a reverse 3:2/2:2 pull-down may be performed on the video if necessary. Typically, the video processing that is used to perform a reverse 3:2/2:2 pull-down may undergo a processing delay of 3 field periods, for example. While this type of delay would not affect the viewing of a movie or typical television program, this would significantly affect playability of an interactive video game.

211 A multi-mode video deinterlacer may reside within a television set, a set-top-box, or a video conferencing console, for example. As external video sources, a game console or a multimedia player may supply video to the television set, the set-top-box, or the video conferencing console. Further, the multi-mode video deinterlacer may receive video from one or more internal sources within a television set or a set-top-box. For example, the one or more internal sources may comprise an analog or digital television tuner and/or a decoder. When used as a video conferencing tool, the multi-mode deinterlacer may be used within a video conferencing console. The video conferencing console may comprise a computer capable of holding the multi-mode deinterlacer, for example. The computer and/or multi-mode deinterlacer may be configured to provide an appropriate telecommunications port for the video conferencing session. In a representative embodiment, the multi-mode video deinterlacer may provide an enhanced experience when used for video conferencing purposes. The multi-mode video deinterlacer may be employed within a video conferencing console, to reduce or minimize video processing delays during an interactive videoconferencing session as necessary. In other instances, the video conferencing console may operate or function as a computer to provide viewing of movies or other programs using an integrated DVD player, for example.

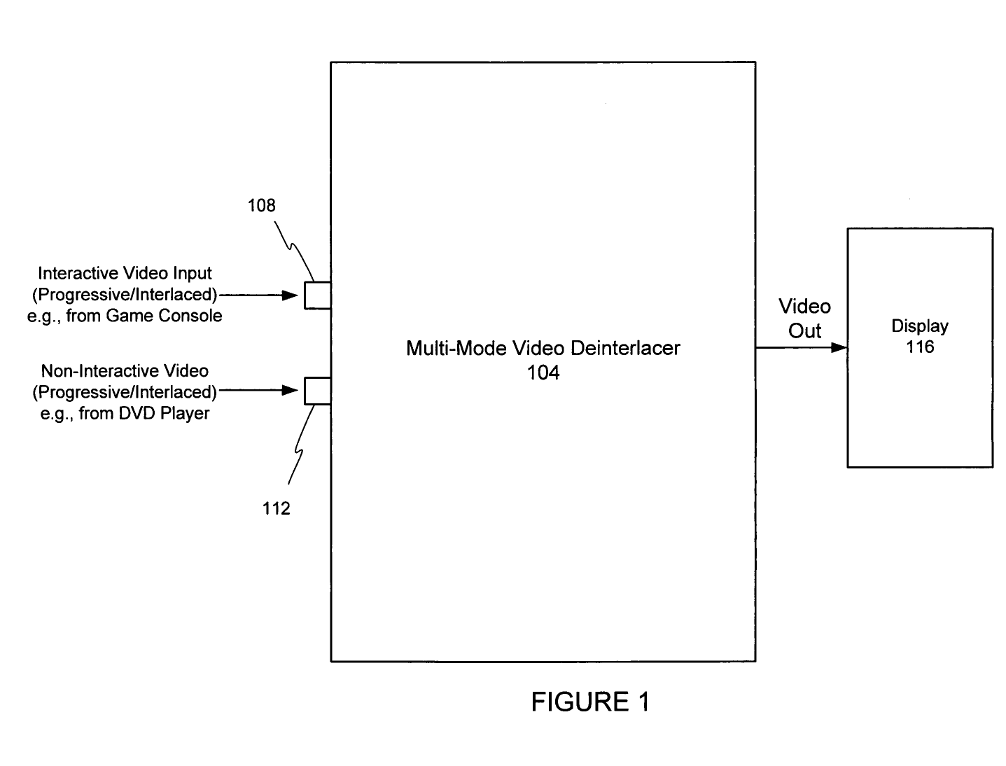

FIG. 1 is a block diagram of a multi-mode video deinterlacer 104 that is used to deinterlace interactive or non-interactive video when an interactive game console and/or a multimedia player is connected to the multi-mode video deinterlacer 104 by way of using two connectors 108, 112, in accordance with an embodiment of the invention. The multimedia player may comprise a DVD or Blu-ray disc player, for example. The multi-mode video deinterlacer 104 may perform image quality enhancement as part of the deinterlacing process. In this representative embodiment, a first connector 108 receives an interactive video game from a game console while a second connector 112 receives a non-interactive video program from a multimedia player. Each of the first and second connectors 108, 112 may comprise an RCA connector, S-Video connector, or any connector capable of transmitting multimedia data. Although not shown, the multi-mode video deinterlacer 104 may receive non-interactive or interactive video from one or more internal sources within a television set or set-top-box. For example, one or more analog or digital television tuners and/or a decoders may provide such non-interactive and/or interactive video. The multi-mode video deinterlacer 104 provides an output to a display 116 where the video may be viewed by a viewer or gamer. In a representative embodiment, the display may be part of a television set. In another representative embodiment, the display may comprise a monitor connected to a set-top-box, for example.

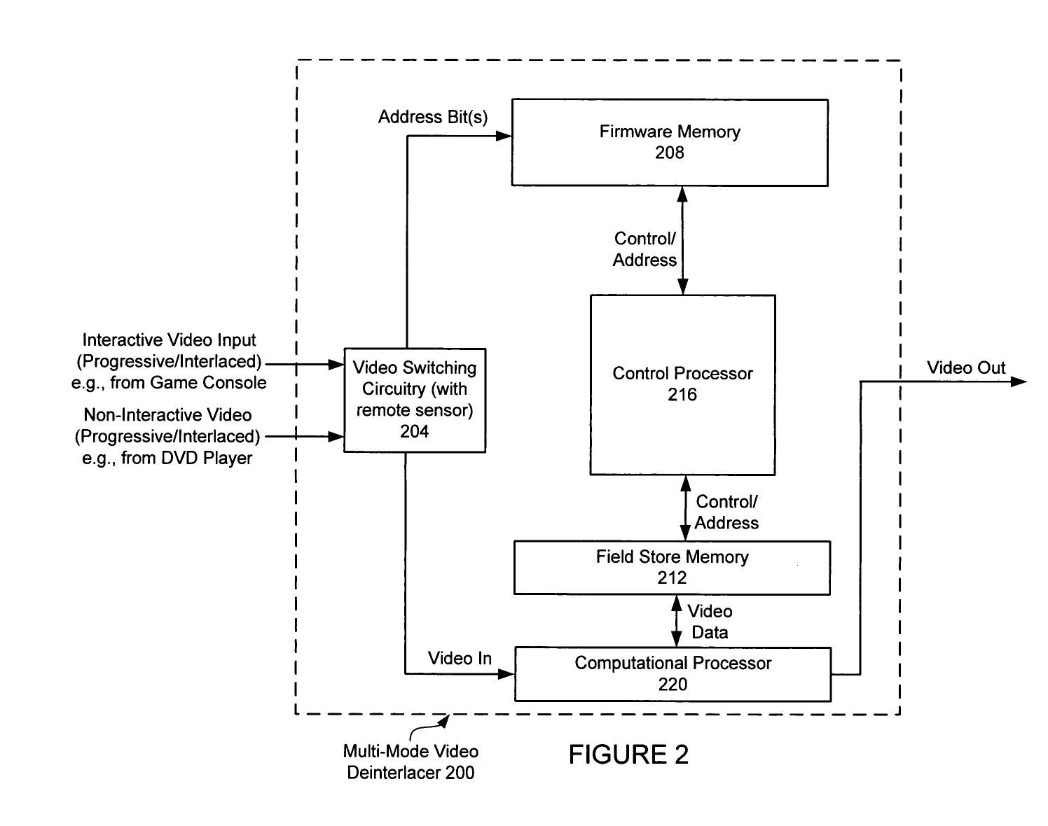

FIG. 2 is a detailed block diagram of a multi-mode video deinterlacer 200 used to deinterlace interactive or non-interactive video when an interactive game console and/or a multimedia player is connected to the multi-mode deinterlacer 200 using two connectors, in accordance with an embodiment of the invention. The multimedia player may comprise a DVD or Blu-ray disc player, for example. The multi-mode video deinterlacer 200 comprises a video switching circuitry 204, a firmware memory 208, a field store memory 212, a control processor 216, and a computational processor 220. The multi-mode video deinterlacer 200 may be physically configured as a module within a television set or set-top-box, for example. A user may transmit commands to an infrared receiver of the video switching circuitry 204. The commands may be transmitted by way of a wireless infrared remote control, for example. A command may facilitate the selection of one of two inputs (i.e., a game input or a DVD player input) connected to the multi-mode video deinterlacer 200 in the television set. Video connections for each of the two inputs may be facilitated using the connectors previously described in connection with FIG. 1. By way of the selection, the appropriate video processing mode may be electronically determined and configured by the multi-mode video deinterlacer 200. For example, the video processing mode may comprise an interactive video processing mode or a non-interactive video processing mode. By way of the selection, only one of the two inputs is used for deinterlacing through the multi-mode video deinterlacer 200. The interactive input may be used to provide game video received from a game console while the non-interactive input may be used to provide movies or programs received from a DVD player. The interactive and non-interactive video may comprise interlaced or non-interlaced progressive video. The non-interactive video may comprise interlaced 3:2 pull-down video that may be provided by a DVD player, for example. By way of selecting either the interactive or non-interactive input, the video switching circuitry 204 may be appropriately switched such that one or more address bit(s) are appropriately transmitted to the firmware memory 208. The one or more address bit(s) may be used to access and execute certain instructions or software code stored in the firmware memory 208, based on the input selection made by the user. The one or more address bit(s) may be used to point to appropriate portions of executable code stored in the firmware memory 208. The appropriate portions of executable code may be accessed based on whether the received video is interactive video or non-interactive video, for example. The firmware memory 208 may comprise a flash memory, for example. The instructions may be stored in the firmware memory 208 before the television set is sold to a consumer or user. The instructions may be executed by the control processor 216 using control/address bits that are transmitted by the control processor 216 to the firmware memory 208. The sequence of instructions that are executed may determine the type of video processing performed by the computation processor 220. Furthermore, the sequence of instructions that are executed may determine the manner in which video fields are written and read out of the field store memory 212. For example, when interactive video such as game video is received, the interactive video may be retrieved from the field store memory as soon as it is stored, such that the interactive video incurs very little delay through the multi-mode video deinterlacer 200. Otherwise, when non-interactive video is received, the sequence of instructions that are executed may facilitate a delay through the deinterlacer 200, such that the computational processor 220 may perform reverse 3:2/2:2 pull-down deinterlacing along with one or more computations to improve or enhance the image quality of the deinterlaced non-interactive video. As shown, the control processor 216 provides control/address bits to the field store memory 212 when video fields are written or read out of the field store memory 212. Video that is initially received by the video switching circuitry 204 is transmitted to the computational processor 220 where deinterlacing, if necessary, may take place. Should the video comprise a non-interlaced progressive interactive (e.g., game) video, no processing is performed by the multi-mode video deinterlacer 200 and the video may be simply passed through the computational processor 220 and out of the multi-mode video deinterlacer 200. In this representative embodiment, the computational processor 220 performs no processing and the throughput delay of the multi-mode video deinterlacer 200 is minimal. However, should the received video comprise an interlaced interactive (e.g., game) video, the control processor 216 may facilitate a minimal processing by the computational processor 220 such that little delay is incurred through the multi-mode video deinterlacer 200 during the deinterlacing process. In this instance, deinterlacing of the interlaced interactive video is performed, and the delay incurred through the multi-mode deinterlacer 200 may amount to less than one field period. The minimal processing may also comprise some amount of image quality improvement by way of computational algorithms and/or methods, for example. In this fashion, the interactive video may suffer very little delay through the multi-mode video deinterlacer 200. If the video comprises a progressive non-interactive video, no processing is performed by the multi-mode video deinterlacer 200 and processing by the computational processor 220 is bypassed, as the progressive non-interactive video is output by the multi-mode video deinterlacer 200. However, should the video comprise an interlaced non-interactive video, the computational processor 220 may use a number of computational algorithms and/or methods to improve or enhance the visual quality of the non-interactive video stream while deinterlacing the interlaced non-interactive video, resulting in significant delay. Further, the deinterlacing process may incorporate a reverse 3:2/2:2 pull-down. In a representative embodiment, the delay through the multi-mode video deinterlacer 200 when interlaced non-interactive video is received may be approximately three field periods. These delays are tolerable to a viewer since the video comprises non-interactive video. The computational algorithms and/or methods may utilize pixel values from one or more fields previously stored in the field store memory 212. In a representative embodiment, the field store memory 212 may be used as a FIFO (first-in-first-out) buffer to store up to 9 consecutive field periods of received pixel data. Various aspects of such computational algorithms and/or methods may be found in U.S. application Ser. No. 10/945796 (Attorney Docket No. 15450US02) filed Sep. 21, 2004, and U.S. patent application Ser. No. 10/945817 (Attorney Docket No. 15451US02) filed Sep. 21, 2004, which are hereby incorporated herein by reference in their entireties. Furthermore, should the interlaced non-interactive video comprise an interlaced 3:2/2:2 pull-down video, the computational processor 220 may invoke one or more computational algorithms and/or methods to perform an improved or enhanced deinterlacing of the 3:2/2:2 pull-down video in a visually pleasing manner. Various aspects of such computational algorithms and/or methods used in deinterlacing interlaced 3:2/2:2 pull-down video may be found in U.S. application Ser. No. 10/945587 (Attorney Docket No. 15448US02) filed Sep. 21, 2004, and U.S. patent application Ser. No. 10/871758 (Attorney Docket No. 15449US02) filed Jun. 17, 2004, which are hereby incorporated herein by reference in their entireties. In a representative embodiment, the multi-mode video deinterlacer 200 may convert a 1080i input into a 1080p output, a 480i input into a 480p input, and a 576i input into a 576p output. Although the representative embodiment of the multi-mode video deinterlacer in FIG. 2 illustrates the use of two inputs, alternate embodiments may be adapted to use one or more interactive and non-interactive inputs. While the game console and/or multimedia player inputs may originate externally from the television set, one or more video inputs may be provided from an internal source within the television set. For example, the internal source may comprise an analog or digital tuner/decoder that provides a non-interactive and interactive video input. Accordingly, the video switching circuitry 204 may be used to select from one or more interactive and non-interactive inputs. These inputs may originate external to the television set or set-top-box or may originate internally from within the television set or set-top-box. For example, the video switching circuitry 204 may select from an external game console input, an external DVD player input, and an internal digital tuner/decoder input.

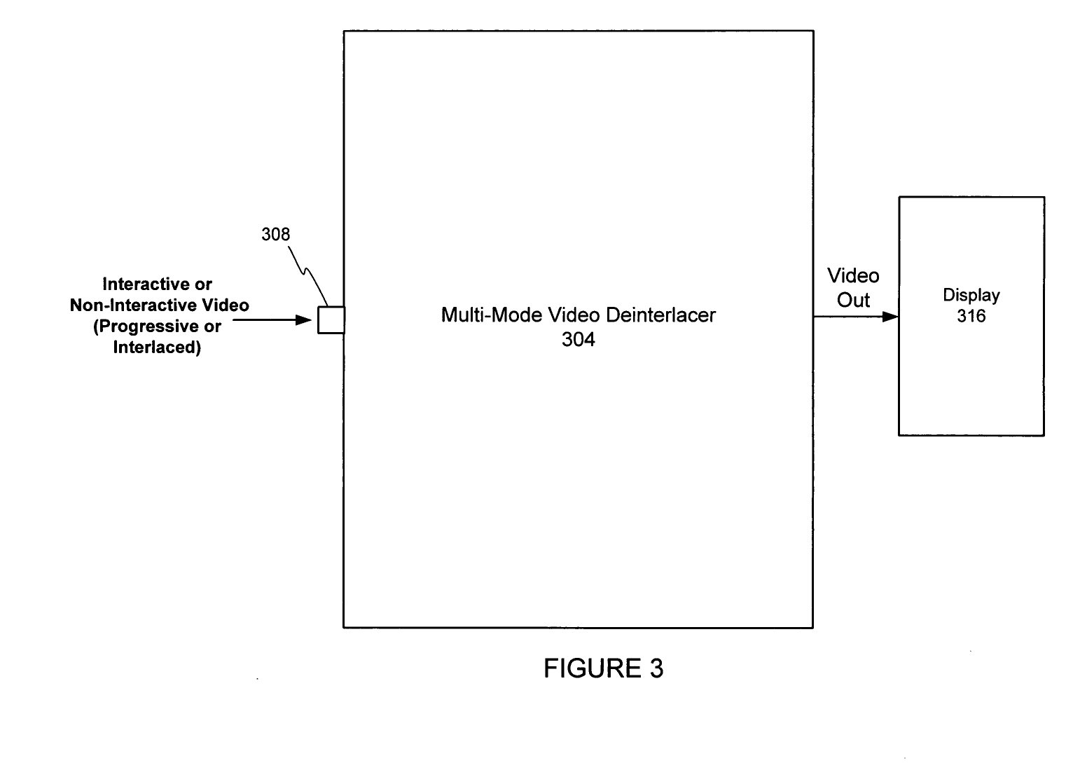

FIG. 3 is a block diagram of a multi-mode video deinterlacer 304 that is used to deinterlace interactive or non-interactive video when an interactive game console and/or a multimedia player is connected to the multi-mode video deinterlacer 304 using a single connector 308, in accordance with an embodiment of the invention. The media player may comprise a DVD or Blu-ray disc player, for example. The multi-mode video deinterlacer 304 may perform image quality enhancement as part of the deinterlacing process. The multi-mode video deinterlacer 304 comprises a single input connector 308 for receiving an interactive or non-interactive video. The interactive or non-interactive video may be progressive or interlaced video. The received video may comprise an interactive video game or non-interactive video program, for example. The connector 308 may comprise an RCA connector, S-Video connector, or any connector capable of providing video data. Although not shown, the multi-mode video deinterlacer 304 may receive non-interactive or interactive video from one or more internal sources within a television set or set-top-box. For example, one or more analog or digital television tuners and/or decoders may provide such non-interactive or interactive video. The multi-mode video deinterlacer 304 provides an output to a display 316 where the video may be viewed by a viewer or gamer. In a representative embodiment, the display may be part of a television set. In another representative embodiment, the display may comprise a monitor connected to a set-top-box, for example.

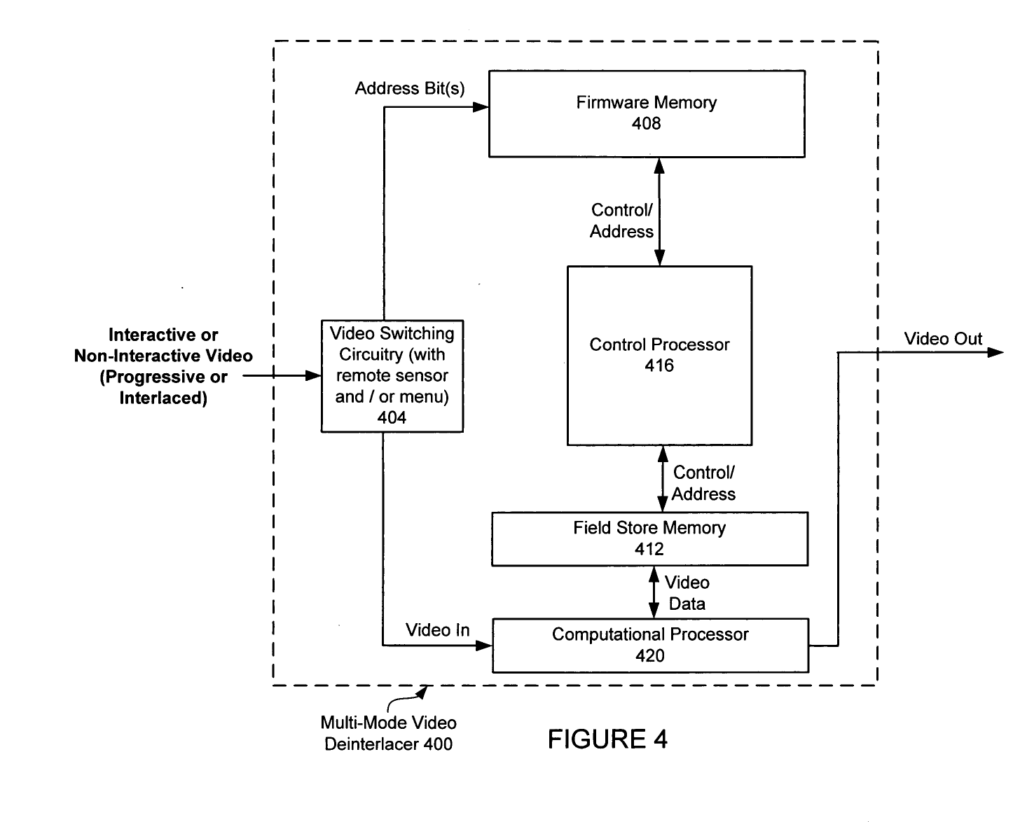

FIG. 4 is a detailed block diagram of a multi-mode video deinterlacer 400 used to deinterlace interactive or non-interactive video when an interactive game console and/or a multimedia player is connected to the multi-mode deinterlacer 400 using a single connector, in accordance with an embodiment of the invention. The multimedia player may comprise a DVD or Blu-ray disc player, for example. The multi-mode video deinterlacer 400 comprises a video switching circuitry 404, a firmware memory 408, a field store memory 412, a control processor 416, and a computational processor 420. The video switching circuitry 404 may comprise an infrared receiver used to receive commands transmitted by a user of an exemplary television set that contains the multi-mode video deinterlacer 400. In a representative embodiment, a command (i.e., a control signal) may be transmitted using a remote control (e.g., a wireless infrared remote control) that selects an entry in a screen menu, for example. The screen menu may comprise a number of entries such as an interactive input mode (e.g., a game input mode) entry or a non-interactive input mode (e.g., a typical DVD program mode) entry, for example. The screen menu may be visualized by using a key on the remote control. By way of using such a command, the multi-mode video deinterlacer may be placed into an interactive or non-interactive processing mode, such that the video switching circuitry 404 may be appropriately switched and one or more address bit(s) are appropriately transmitted to the firmware memory 408. The one or more address bit(s) may be used to access and execute certain instructions or software code stored in the firmware memory 408, based on the command. The one or more address bit(s) may be used to point to appropriate portions of executable code stored in the firmware memory 408. The appropriate portion of executable code may be accessed based on the user's command (i.e., whether the received video is interactive video or non-interactive video). The firmware memory 408 may comprise a flash memory, for example. The instructions may be stored in the firmware memory 408 before the television set is sold to a consumer or user, for example. The control processor 408 and computational processor 420 may function or operate in accordance with the command provided by the user. As a consequence, the multi-mode video deinterlacer 400 will process the video based on this selection, as was described in connection with FIG. 2, and a corresponding processing delay will be incurred. As was described in connection with FIG. 2, the sequence of instructions that are executed may determine the type of video processing performed by the computation processor 420. Furthermore, the sequence of instructions that are executed may determine the manner in which video fields are written and read out of the field store memory 412.

When interactive video such as game video is received from the interactive game console, the interactive video may be retrieved from the field store memory 412 as soon as it is stored, such that the interactive video incurs very little delay through the multi-mode video deinterlacer 400. Otherwise, when non-interactive video is received from the DVD player, the sequence of instructions that are executed may facilitate a delay through the deinterlacer 400, such that the computational processor 420 may perform reverse 3:2/2:2 pull-down deinterlacing along with one or more computations to improve or enhance the image quality of the deinterlaced non-interactive video. As shown, the control processor 416 provides control/address bits to the field store memory 412 when video fields are written or read out of the field store memory 412. Video that is initially received by the video switching circuitry 404 is transmitted to the computational processor 420 where deinterlacing, if necessary, may take place. Should the video comprise a non-interlaced progressive interactive (e.g., game) video, this video may be simply passed through the computational processor 420 and out of the multi-mode video deinterlacer 400. In this representative embodiment, the computational processor 420 performs no processing and the throughput delay of the multi-mode video deinterlacer 400 is minimal. However, should the received video comprise an interlaced interactive (e.g., game) video, the control processor 416 may facilitate minimal or reduced processing by the computational processor 420 such that little delay is incurred through the multi-mode video deinterlacer 400. In this instance, deinterlacing of the interlaced interactive video is performed, and the delay incurred through the multi-mode deinterlacer 400 may amount to less than one field period. The minimal processing may also comprise some amount of image quality improvement by way of computational algorithms and/or methods, for example. In this fashion, the interactive video may suffer very little delay through the multi-mode video deinterlacer 400. If the video comprises a progressive non-interactive video, processing by the computational processor 420 is bypassed, and the progressive non-interactive video is output by the multi-mode video deinterlacer 400. However, should the video comprise an interlaced non-interactive video stream, the computational processor 420 may use a number of computational algorithms and/or methods to improve or enhance the quality of the displayed non-interactive video stream while deinterlacing the interlaced non-interactive video, resulting in a longer delay. In a representative embodiment, the delay through the multi-mode video deinterlacer 400 when interlaced non-interactive video is received may be approximately three field periods. These delays are tolerable since the video comprises a non-interactive video stream. The computational algorithms and/or methods may utilize pixel values from one or more fields previously stored in the field store memory 412. In a representative embodiment, the field store memory 412 may be used as a FIFO (first-in-first-out) buffer to store up to 9 consecutive field periods of received pixel data. Various aspects of such computational algorithms and/or methods may be found in U.S. application Ser. No. 10/945796 (Attorney Docket No. 15450US02) filed Sep. 21, 2004, and U.S. patent application Ser. No. 10/945817 (Attorney Docket No. 15451US02) filed Sep. 21, 2004, which are hereby incorporated herein by reference in their entireties. Furthermore, should the interlaced non-interactive video comprise an interlaced 3:2/2:2 pull-down video, the computational processor 420 may invoke one or more computational algorithms and/or methods to perform an improved or enhanced deinterlacing of the 3:2/2:2 pull-down video in a visually pleasing manner. Various aspects of such computational algorithms and/or methods used in deinterlacing interlaced 3:2/2:2 pull-down video may be found in U.S. application Ser. No. 10/945587 (Attorney Docket No. 15448US02) filed Sep. 21, 2004, and U.S. patent application Ser. No. 10/871758 (Attorney Docket No. 15449US02) filed Jun. 17, 2004, which are hereby incorporated herein by reference in their entireties. In a representative embodiment, the multi-mode video deinterlacer 400 may convert a 1080i input into a 1080p output, a 480i input into a 480p input, and a 576i input into a 576p output. Although the representative embodiment of the multi-mode video deinterlacer in FIG. 4 illustrates the use of two inputs, alternate embodiments may be adapted to use one or more interactive and non-interactive inputs. While the game console and/or multimedia player inputs may originate externally from the television set, one or more video inputs may be provided from an internal source within the television set. For example, the internal source may comprise an analog or digital tuner/decoder that provides a non-interactive or interactive video input. Accordingly, the video switching circuitry 404 may be used to select from one or more interactive and non-interactive inputs. These inputs may originate external to the television set or set-top-box or may originate internally from within the television set or set-top-box. For example, the video switching circuitry 404 may make a selection from an external game console input, an external DVD player input, and an internal digital tuner/decoder input.

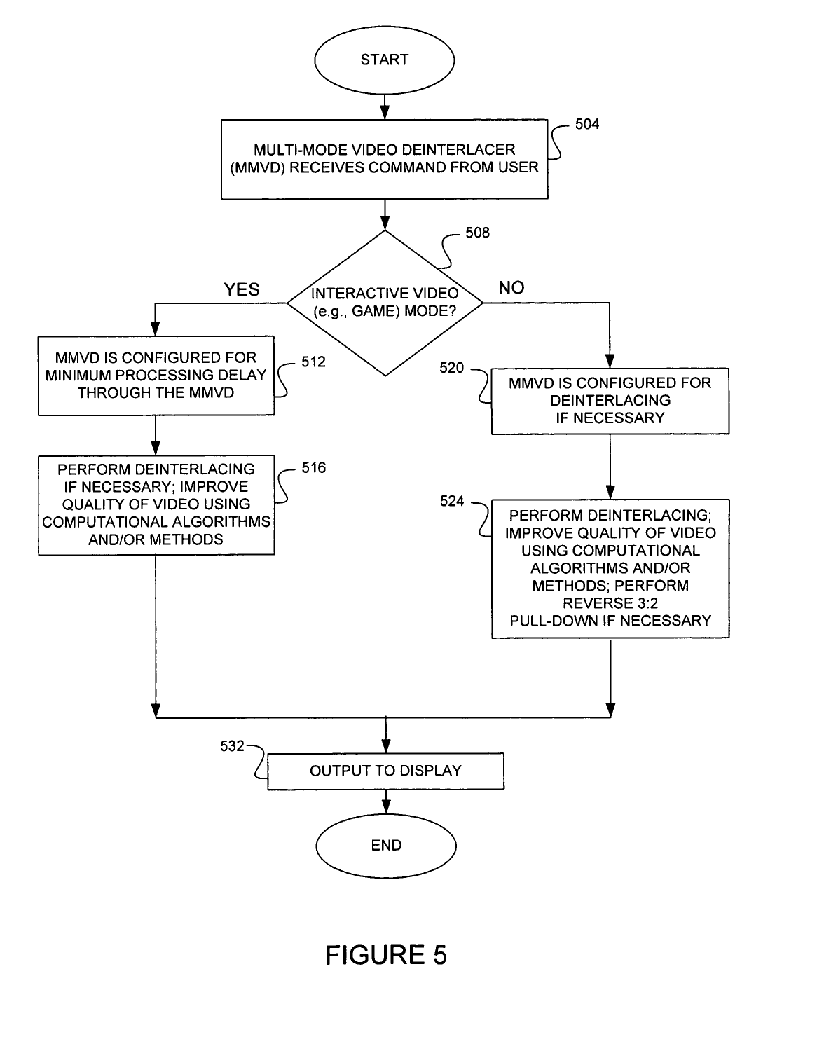

FIG. 5 is an operational flow diagram of a multi-mode video deinterlacer, in accordance with an embodiment of the invention. At step 504, the multi-mode video deinterlacer (MMVD) receives a command or control signal from a user. The command comprises a selection of one of two inputs—an interactive (game) input or a non-interactive (DVD) input. Selection of a particular input activates the corresponding processing mode used by the multi-mode video deinterlacer. The command or control signal may be transmitted using a remote control device, for example. In another representative embodiment, a command may be transmitted using a remote control device that selects an entry in a screen menu, for example. The menu may comprise a number of entries such as an interactive input mode (e.g., a game input mode) entry or a non-interactive input mode (e.g., a typical DVD program mode) entry, for example. Next, at step 508, the MMVD enters an interactive video (e.g., game) mode or a non-interactive video (e.g., movie) mode, based on the command received. If the command calls for the interactive video mode, the process proceeds with step 512. Otherwise, the process proceeds with step 520. At step 512, the MMVD is configured for processing the interactive video using minimum processing delay, such that a gamer will experience little if any lag time between a stimulus and an associated response while playing a game. At step 516, deinterlacing is performed if the interactive video comprises an interlaced video stream. In a representative embodiment, some amount of processing may be performed to correct and improve the image quality of the displayed video; however, the processing time is at a minimum, such that any lag time is minimized. At step 520, the MMVD is configured for deinterlacing the non-interactive video if necessary. Thereafter, at step 524, deinterlacing is performed and the visual quality of the non-interactive video may be improved by way of using computational algorithms and/or methods. If the non-interactive video comprises an interlaced 3:2/2:2 pull-down video, it may undergo a reverse 3:2/2:2 pull-down. In a representative embodiment, three field periods of delay are incurred through the MMVD as a result of performing steps 520 and 524. After step 516 or 524, the process proceeds to step 528, at which either the interactive or non-interactive video is output to a display, for viewing by the user. The display may comprise a television set or monitor, for example.

Various aspects of the multi-mode video deinterlacer described in connection with FIGS. 1-4 may be adapted for use within a video conferencing console to reduce lag time during a video conferencing session. The video conferencing console may comprise a computer that contains the one or more elements described in the multi-mode video deinterlacer. In a representative embodiment, the multi-mode deinterlacer may be configured for incorporation into a PCI card slot of the computer, for example. In this representative embodiment, the connector(s) described in reference to FIGS. 1-4 may be replaced with a telecommunication port such as an Ethernet port, for example.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of processing a video through a video deinterlacer comprising:
receiving a control signal that indicates whether said video is an interactive video or a non-interactive video; and
deinterlacing said video such that an amount of delay to said video is incurred through said video deinterlacer, said amount of delay based on said control signal.

2. The method of claim 1 wherein said video comprises interlaced or non-interlaced video, said non-interlaced video bypassed through said video deinterlacer.

3. The method of claim 1 wherein said amount of delay comprises less than one field period of said video when said video comprises interactive video.

4. The method of claim 3 wherein said interactive video comprises a video game.

5. The method of claim 3 wherein said interactive video comprises video conferencing data.

6. The method of claim 1 wherein said amount of delay comprises at least one field period of said video when said video comprises an interlaced non-interactive video.

7. The method of claim 6 wherein at least one field period comprises three field periods.

8. The method of claim 1 wherein said deinterlacing comprises image correction and image quality improvement of said video.

9. The method of claim 1 wherein said deinterlacing comprises performing a reverse 3:2/2:2 pull-down of said video if said video comprises an interlaced non-interactive video.

10. The method of claim 1 wherein said video deinterlacer is part of a television set.

11. The method of claim 1 wherein said video deinterlacer is part of a set-top-box.

12. The method of claim 1 wherein said video deinterlacer is part of a video conferencing console.

13. The method of claim 12 wherein said video conferencing console comprises a computer.

14. The method of claim 1 wherein said control signal originates from a wireless remote control.

15. The method of claim 1 wherein said control signal is transmitted in part by use of a screen menu.

16. A multi-mode video deinterlacer for deinterlacing video comprising:
one or more first inputs for providing interactive video to said multi-mode video deinterlacer;
one or more second inputs for providing non-interactive video to said multi-mode video deinterlacer; and
a circuitry for selecting one input of said one or more first or said one or more second inputs, said one input used to provide said video to said multi-mode video deinterlacer, said selecting based on a control signal, wherein an amount of processing delay to said video is incurred through said multi-mode video deinterlacer based on said control signal.

17. The multi-mode video deinterlacer of claim 16 wherein said one or more first inputs and said one or more second inputs is provided to said multi-mode video deinterlacer by way of one or more corresponding external connectors.

18. The multi-mode video deinterlacer of claim 17 wherein one or more labels are applied next to said one or more corresponding external connectors, said one or more labels identifying each of said one or more corresponding external connectors as an interactive video input or a non-interactive video input.

19. The multi-mode video deinterlacer of claim 16 further comprising:
one or more memories capable of storing executable code and video data;
executable code stored in said one or more memories;
a first processor for executing said executable code and for addressing said one or more memories; and
a second processor for performing a reverse 3:2/2:2 pull-down of said video.

20. The multi-mode video deinterlacer of claim 16 wherein said video comprises interlaced or non-interlaced video, said non-interlaced video bypassed through said multi-mode video deinterlacer.

21. The system of claim 16 wherein said control signal originates from a wireless remote control.

22. The system of claim 16 wherein said control signal is transmitted in part by use of a screen menu.

23. The system of claim 16 wherein said amount of delay is effectuated by way of storing and retrieving one or more fields into said one or more memories.

24. The system of claim 16 wherein said amount of delay comprises less than one field period of said video when said video comprises interactive video.

25. The system of claim 16 wherein said amount of delay comprises at least one field period of said video when said video comprises non-interactive video.

26. The system of claim 15 wherein at least one field period comprises three field periods.

27. The system of claim 15 wherein said deinterlacing comprises performing a reverse 3:2/2:2 pull-down of said video if said video comprises non-interactive video.

28. A system for deinterlacing video comprising:
a connector for connecting said video; and
a circuitry for selecting whether said video is an interactive video or a non-interactive video based on a control signal, wherein said deinterlacing of said video is performed such that an amount of delay to said video is incurred through said system, said amount of delay based on said control signal.

29. The multi-mode video deinterlacer of claim 28 further comprising:
one or more memories capable of storing executable code and video data;
executable code stored in said one or more memories;
a first processor for executing said executable code and for addressing said one or more memories; and
a second processor for performing a reverse 3:2/2:2 pull-down of said video.

30. The system of claim 28 wherein said amount of delay comprises less than one field period of said video when said video comprises interactive video.

31. The system of claim 28 wherein said amount of delay comprises at least one field period of said video when said video comprises non-interactive video.
